(19) United States
(12) Patent Application Publication
(10) Pub. No.: US 2026/0347526 A1
(43) Pub. Date: Nov. 5, 2026

(54) FUNCTIONAL DIENE ELASTOMER, AND RUBBER COMPOSITION CONTAINING SAME

(71) Applicant: Compagnie Generale Des Etablissements Michelin, Clermont-Ferrand (FR)

(72) Inventors: Thomas FERRAND, Clermont-Ferrand (FR); Nicolas WAECKERLE, Clermont-Ferrand (FR); Romain LIBERT, Clermont-Ferrand (FR)

(73) Assignee: Compagnie Generale Des Etablissements Michelin, Clermont-Ferrand (FR)

(21) Appl. No.: 19/491,102

(22) PCT Filed: Jun. 6, 2024
(86) PCT No.: PCT/EP2024/065642

§ 371 Date: Dec. 8, 2025

(30) Foreign Application Priority Data
Jun. 8, 2023 (FR) 2305781

(51) Int. Cl. C08F 279/02; B60C 1/00; C08J 3/20; C08K 3/04; C08K 3/06; C08K 3/22; C08K 5/103; C08K 5/18; C08K 5/3465; C08K 5/47; C08L 51/00

(52) U.S. Cl. CPC C08F 279/02; B60C 1/0016; C08J 3/203; C08K 3/04; C08K 3/06; C08K 5/103; C08K 5/18; C08K 5/3465; C08K 5/47; C08L 51/003; C08K 2003/2296

(57) ABSTRACT

A diene elastomer, which diene elastomer is a copolymer of 1,3-butadiene and styrene and is functionalized with pendent imidazole groups is provided. The diene elastomer contains 1,4-trans-linked butadiene units and 1,2-linked butadiene units, respectively representing more than 70 mol % of the butadiene units of the diene elastomer and less than 10 mol % of the butadiene units of the diene elastomer. The diene elastomer confers a rubber composition, especially for a tire tread, with excellent crack propagation resistance properties.

### CROSS REFERENCE TO RELATED APPLICATIONS

This U.S. patent application is a national phase entry of PCT Patent Application No. PCT/EP2024/065642, filed Jun. 6, 2024, which claims priority to French Patent Application No. FR 2305781, filed Jun. 8, 2023, the entire contents of which are incorporated herein by reference in their entirety.

### BACKGROUND

### 1. Technical Field

The present invention relates to a functional diene elastomer intended to be used in a rubber composition, in particular a rubber composition for a tire.

### 2. Related Art

The applicant has described copolymers of 1,3-butadiene and styrene having a very low 1,2-linkage content, typically less than 8 mol % of the butadiene units, and a high 1,4-trans-linkage content, typically greater than 70 mol % of the butadiene units, while retaining an elastomeric character. The synthesis of such elastomers, for example described in documents FR 2273822 A1 and WO 2004099277 A1, generally requires the use of a catalytic composition containing three organometallic compounds, namely a barium alkoxide, an organoaluminium compound and an organolithium compound. These elastomers are distinguished from emulsion elastomers—diene elastomers synthesized in emulsion via the radical route—in particular both by their low 1,2-linkage content and their high 1,4-trans-linkage content. They are also known to confer a rubber composition with mechanical properties at break which are far superior to the rubber compositions containing emulsion diene elastomers, as demonstrated in document FR 227822 A1.

There remains a need to improve the mechanical properties of rubber compositions containing diene elastomers having a very low 1,2-linkage content and a high 1,4-trans-linkage content.

### SUMMARY

The inventors have discovered that the crack propagation resistance of rubber compositions containing a copolymer of 1,3-butadiene and styrene having a very low 1,2-linkage content and a high 1,4-trans-linkage content is improved by introducing pendent imidazole functions into the copolymer.

Thus, a first subject of the invention is a diene elastomer which is a copolymer of 1,3-butadiene and styrene and which is functionalized with pendent imidazole groups of formula (I)

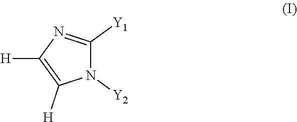

in which:
Y₁ represents a hydrogen atom or a carbon chain that may contain at least one heteroatom,
Y₂ denotes an attachment to a butadiene unit of the diene elastomer,
which diene elastomer contains 1,4-trans-linked butadiene units and 1,2-linked butadiene units,
the 1,4-trans-linked butadiene units representing more than 70 mol % of the butadiene units of the diene elastomer,
the 1,2-linked butadiene units representing less than 10 mol % of the butadiene units of the diene elastomer.

A second subject of the invention is a rubber composition which comprises a diene elastomer in accordance with the invention, a reinforcing filler, and a crosslinking system.

A third subject of the invention is a process for preparing a rubber composition in accordance with the invention, which process comprises the following steps:
during a “non-productive” step, kneading a starting diene elastomer and a 1,3-dipolar compound by thermomechanically kneading,
the starting diene elastomer being a copolymer of 1,3-butadiene and styrene which contains more than 70 mol % of 1,4-trans-linked butadiene units and less than 10 mol % of 1,2-linked butadiene units, the molar percentages of the 1,4-trans-linked butadiene units and the 1,2-linked butadiene units being calculated relative to the total number of butadiene units in the starting diene elastomer,
the 1,3-dipolar compound being a compound containing a dipole selected from a nitrile oxide, a nitrile imine and a nitrone and containing a group of formula (II) in which Z₁ represents a hydrogen atom or a carbon chain that may contain at least one heteroatom and Z₂ denotes an attachment to the dipole,

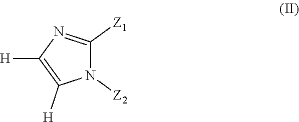

subsequently adding the reinforcing filler and, if appropriate, the other ingredients of the rubber composition, with the exception of the crosslinking system, by thermomechanically kneading until a maximum temperature of between 13° and 200 °C is reached, in order to obtain a mixture,
cooling the mixture to a temperature of less than 100 °C,
subsequently incorporating the crosslinking system,
kneading the mixture and the crosslinking system up to a maximum temperature of less than 120 °C.

A fourth subject of the invention is a tyre comprising a rubber composition preferentially in its tread, which rubber composition is a rubber composition in accordance with the invention or obtained according to a process in accordance with the invention for preparing said composition.

### DETAILED DESCRIPTION OF EXAMPLE EMBODIMENTS

The abbreviation “phr” means parts by weight per hundred parts of elastomer (of the total of the elastomers if a plurality of elastomers are present).

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The compounds mentioned in the description may be of fossil origin or may be biobased. In the latter case, they may be partially or completely derived from biomass or obtained from renewable raw materials derived from biomass. Similarly, the compounds mentioned may also originate from the recycling of already-used materials, i.e. they may partially or completely result from a recycling process, or else be obtained from raw materials which themselves result from a recycling process.

In the present invention, a “tire” is understood to mean a pneumatic or non-pneumatic tire. A pneumatic tire usually comprises two beads intended to come into contact with a rim, a crown composed of at least one crown reinforcement and a tread, and two sidewalls, the tire being reinforced by a carcass reinforcement anchored in the two beads. A non-pneumatic tire, for its part, usually comprises a base, designed for example for mounting on a rigid rim, a crown reinforcement ensuring the connection with a tread, and a deformable structure, such as spokes, ribs or cells, this structure being arranged between the base and the crown. Such non-pneumatic tires do not necessarily comprise a sidewall. Non-pneumatic tires are described for example in documents WO 03/018332 and FR2898077. According to any one of the embodiments of the invention, the tire according to the invention is preferentially a pneumatic tire.

The diene elastomer in accordance with the invention has the essential feature of being a functionalized copolymer of 1,3-butadiene and styrene which contains 1,4-trans-linked butadiene units and 1,2-linked butadiene units. In the diene elastomer in accordance with the invention, the 1,4-trans-linked butadiene units represent more than 70 mol % of the butadiene units of the diene elastomer in accordance with the invention, the 1,2-linked butadiene units representing less than 10 mol % of the butadiene units of the diene elastomer in accordance with the invention. Preferably, the 1,4-trans-linked butadiene units represent more than 75 mol % of the butadiene units of the diene elastomer in accordance with the invention. Also preferably, the 1,2-linked butadiene units represent less than 8 mol % of the butadiene units of the diene elastomer in accordance with the invention. The diene elastomer in accordance with the invention preferentially comprises between 5% and 45% by mass of styrene, more preferentially between 15% and 40% by mass of styrene, more preferentially still between 25% and 35% by mass of styrene. Conventionally and as is well known to those skilled in the art, the content of styrene in an elastomer is given per 100 g of elastomer. For example, an elastomer containing 10% of styrene is an elastomer in which the proportion of styrene in the form of monomer unit is 10 g per 100 g of this elastomer.

The diene elastomer in accordance with the invention also has another essential feature, of bearing functional groups. The functional groups are pendent imidazole groups of formula (I)

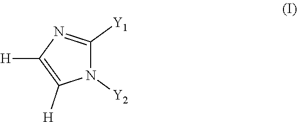

in which Y₁ represents a hydrogen atom or a carbon chain that may contain at least one heteroatom, Y₂ denotes an attachment to a butadiene unit of the diene elastomer in accordance with the invention. Those skilled in the art understand that the functional groups are attached to the diene elastomer in accordance with the invention by covalent bonding. The attachment to a butadiene unit may be direct or indirect, i.e. through a group of atoms. It is preferably indirect. In the present application, a group of atoms is understood to mean a sequence of atoms covalently bonded to form a chain.

Advantageously, Y₁ is a hydrogen atom or an alkyl group. When the symbol Y₁ represents an alkyl group, the alkyl group is preferentially a C₁-C₆ alkyl, more preferentially a methyl. A C₁-C₆ alkyl is understood to mean an alkyl which contains from 1 to 6 carbon atoms. Very advantageously, Y₁ is a methyl group.

According to any one of the embodiments of the invention, the pendent imidazole groups of formula (I) are preferably distributed randomly along the diene elastomer chain.

The molar content of pendent imidazole groups of formula (I) in the diene elastomer in accordance with the invention is preferentially at most 3 mol % of the constituent repeating units of the diene elastomer in accordance with the invention in order to obtain the best compromise between the properties of the rubber composition containing the diene elastomer in accordance with the invention and its additional cost compared to a rubber composition containing a diene elastomer devoid of pendent imidazole groups. It varies preferentially within a range which extends from more than 0 mol % to 3 mol % of the constituent repeating units of the diene elastomer in accordance with the invention, for example from 0.02 mol % to 3 mol % of the constituent repeating units of the diene elastomer in accordance with the invention, more preferentially still from 0.1 mol % to 3 mol % of the constituent repeating units of the diene elastomer in accordance with the invention. These preferential ranges may apply to any one of the embodiments of the invention.

According to a particular embodiment of the invention, the diene elastomer in accordance with the invention may be a mixture of a plurality of elastomers which may differ from one another in their microstructure and their macrostructure. Each of the elastomers making up the mixture corresponds to the definition of the diene elastomer in accordance with the invention both from the point of view of the functionalization and of the microstructure.

According to a particularly preferred embodiment of the invention, the diene elastomer in accordance with the invention is obtained by modifying a starting diene elastomer by a reaction of grafting a 1,3-dipolar compound. The 1,3-dipolar compound contains a dipole selected from a nitrile oxide, a nitrile imine and a nitrone and contains a group of formula (II) in which Z₁ is identical to Y₁ of formula (I) and Z₂ denotes an attachment to the dipole. The dipole is preferentially a nitrile oxide.

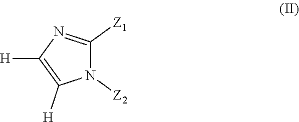

Preferably, the symbol Z₁ represents a hydrogen atom or a carbon chain that may contain at least one heteroatom, in particular an alkyl, more particularly a C₁-C₆ alkyl. Advantageously, the alkyl group represented by Z₁ is a methyl.

The starting diene elastomer is a copolymer of 1,3-butadiene and styrene which contains more than 70 mol % of 1,4-trans-linked butadiene units and less than 10 mol % of 1,2-linked butadiene units, the molar percentages of the 1,4-trans-linked butadiene units and the 1,2-linked butadiene units being calculated relative to the total number of butadiene units in the starting diene elastomer. Preferentially, the starting diene elastomer is a copolymer of 1,3-butadiene and styrene which contains more than 75 mol % of 1,4-trans-linked butadiene units and less than 8 mol % of 1,2-linked butadiene units, the molar percentages of the 1,4-trans-linked butadiene units and the 1,2-linked butadiene units being calculated relative to the total number of butadiene units in the starting diene elastomer. The starting diene elastomer preferentially comprises between 5% and 45% by mass of styrene, more preferentially between 15% and 40% by mass of styrene, more preferentially still between 25% and 35% by mass of styrene. The starting diene elastomer can be synthesized according to the process described in patent applications EP 0037617 A1, WO 03037946 A2, WO 2004099277 A1.

In the synthesis of the diene elastomer in accordance with the invention, the dipole of the 1,3-dipolar compound typically reacts with the carbon-carbon double bonds of the butadiene units of the starting diene elastomer. The 1,3-dipolar compound useful for the purposes of the invention is preferably an aromatic mononitrile oxide, i.e. an aromatic compound that contains a single nitrile oxide dipole, in particular a compound that contains a benzene ring and a single nitrile oxide dipole and in which the benzene ring is substituted by the nitrile oxide dipole. Advantageously, the benzene ring is substituted in the position ortho to the dipole.

Advantageously, the 1,3-dipolar compound contains a moiety of formula (III) in which four of the six symbols R₁ to R₆, which may be identical or different, are each an atom or a group of atoms, knowing that the fifth symbol represents an attachment to the group of formula (II) and the sixth symbol a direct attachment to the dipole.

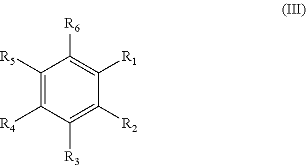

According to a particularly preferred embodiment, in formula (III) R₆ represents a direct attachment to the dipole, and the symbols R₁ and R₅ are both other than a hydrogen atom, which makes it possible to confer a greater stability of the 1,3-dipolar compound and thus an easier use of the 1,3-dipolar compound. According to this particularly preferred embodiment, the symbols R₁, R₃ and R₅ each preferably represent a hydrocarbon group, more preferentially an alkyl, more preferentially still a methyl or an ethyl, and one of the symbols R₂ and R₄ is preferentially a hydrogen atom. With a benzene ring thus substituted, the synthesis of the 1,3-dipolar compound may then be carried out using a relatively easy synthesis route using a commercially available precursor, for example mesitylene, as is described in particular in the document WO 2015059269.

In formula (III), the fifth symbol is attached to the group of formula (II), preferably via a group of atoms referred to as a spacer. The spacer is preferably a carbon chain which may contain at least one heteroatom. The spacer preferably contains 1 to 6 carbon atoms, in particular 1 to 3 carbon atoms. The spacer is more preferentially an alkanediyl group, better still methanediyl.

According to any one of the embodiments of the invention, the 1,3-dipolar compound is advantageously the compound 2,4,6-trimethyl-3-((2-methyl-1H-imidazol-1-yl)methyl)benzonitrile oxide of formula (III-a) or the compound 2,4,6-triethyl-3-((2-methyl-1H-imidazol-1-yl)methyl)benzonitrile oxide of formula (III-b), more advantageously the compound of formula (III-a).

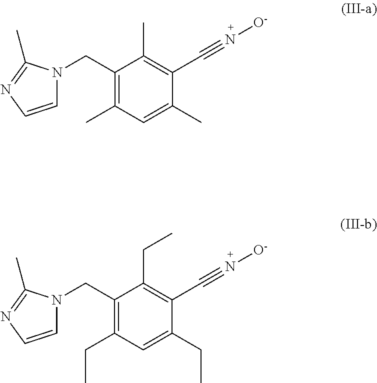

The diene elastomer in accordance with the invention is intended to be used in a rubber composition, in particular a rubber composition for a tire, another subject of the invention.

The rubber composition also has the essential feature of comprising a reinforcing filler.

The total content of the reinforcing filler in the rubber composition may vary widely. It is adjusted depending on the use for which the rubber composition is intended, in particular in a tire. The total content of reinforcing filler is preferentially between 40 and 80 phr. A content of less than or equal to 40 phr may lead to a reinforcement of the rubber composition after crosslinking which may be judged to be insufficient for use in a tread for a tire. A content of greater than or equal to 80 phr may lead to a level of hysteresis which may be considered to be too high for use in a tread, in particular for a tire intended to equip a heavy-duty vehicle or a civil engineering vehicle.

The reinforcing filler can be any type of “reinforcing” filler known for its abilities to reinforce a rubber composition which can be used for the manufacture of tires, for example carbon black, a reinforcing inorganic filler, such as silica, with which is combined, in a known way, a coupling agent, or else a mixture of these two types of filler. Such a reinforcing filler typically consists of nanoparticles, the (mass-) average size of which is less than a micrometre, generally less than 500 nm, usually between 20 and 200 nm, in particular and more preferentially between 20 and 150 nm.

The reinforcing filler preferentially contains a carbon black. All carbon blacks, in particular the blacks conventionally used in tires or their treads (“tire-grade” blacks), are suitable as carbon blacks. Among the latter, mention will more particularly be made of the reinforcing carbon blacks of the 100, 200 or 300 series, or the blacks of the 500, 600 or 700 series (ASTM grades, respectively also known under the acronyms SAF, ISAF, HAF, FF, GPF and SRF), such as for example the N115, N134, N234, N326, N330, N339, N347, N375, N550, N683 and N772 blacks). These carbon blacks can be used in the isolated state, as commercially available, or in any other form, for example as support for some of the rubber additives used.

The carbon black preferentially represents more than 50% by mass of the reinforcing filler, more preferentially more than 90% by mass of the reinforcing filler. According to any one of the embodiments of the invention, the carbon black advantageously represents 100% by mass of the reinforcing filler.

The rubber composition may comprise an elastomer other than the diene elastomer in accordance with the invention. In particular, this other elastomer may be an unmodified diene elastomer, for example the starting diene elastomer used in the preparation of the diene elastomer in accordance with the invention.

The content of the diene elastomer in accordance with the invention in the rubber composition is preferentially at least 50 phr, more preferentially at least 75 phr, more preferentially still at least 90 phr. The content of diene elastomer in accordance with the invention in the rubber composition therefore varies preferentially from 50 to 100 phr, more preferentially from 75 to 100 phr, more preferentially still from 90 to 100 phr. The higher the content of the diene elastomer in accordance with the invention in the rubber composition, the better the crack propagation resistance of the rubber composition. These preferential contents of diene elastomer in accordance with the invention in the rubber composition may apply to any one of the embodiments of the invention.

The rubber composition contains a system for crosslinking the diene elastomer in accordance with the invention and, if applicable, a diene elastomer other than the diene elastomer in accordance with the invention. The crosslinking system may be a vulcanization system or may be based on one or more peroxide compounds, for example conventionally used in rubber compositions that can be used for the manufacture of tires. The crosslinking system is preferentially a vulcanization system, that is to say a system based on sulfur (or on a sulfur-donating agent) and on a primary vulcanization accelerator. Various known secondary vulcanization accelerators or vulcanization activators, such as zinc oxide, stearic acid or an equivalent compound, or guanidine derivatives (in particular diphenylguanidine), or else known vulcanization retarders, are added to this base vulcanization system, being incorporated during the first non-productive phase and/or during the productive phase, as described subsequently. Sulfur is used in a preferential content of between 0.5 and 5 phr, in particular between 1 and 3 phr. The primary vulcanization accelerator is used in a preferential content of between 0.5 and 5 phr, in particular between 0.5 and 3 phr.

The rubber composition may additionally contain other additives known to be used in rubber compositions for tires, such as pigments, processing aids, antiozonants or antioxidants. Those skilled in the art will know how to adjust the formulation of the rubber composition depending on their specific requirements.

The rubber composition in accordance with the invention is typically manufactured in appropriate mixers, using two successive phases of preparation well known to those skilled in the art: a first phase of working, step of thermomechanical kneading (“non-productive” phase) at high temperature, up to a maximum temperature of between 130 °C and 200 °C, followed by a second phase of mechanical working (“productive” phase) down to a lower temperature, typically of less than 110 °C, for example between 40 °C and 100 °C, during which finishing phase the crosslinking system is incorporated.

The rubber composition, according to a particular embodiment of the invention, may be manufactured according to a process which comprises the following steps:
during a “non-productive” step, kneading a starting diene elastomer and a 1,3-dipolar compound by thermomechanically kneading,
the starting diene elastomer being a copolymer of 1,3-butadiene and styrene which contains more than 70 mol % of the 1,4-trans-linked butadiene units and less than 10 mol % of the 1,2-linked butadiene units, the molar percentages of the 1,4-trans-linked butadiene units and the 1,2-linked butadiene units being calculated relative to the total number of butadiene units in the starting diene elastomer,
the 1,3-dipolar compound being as defined above according to any one of the embodiments,
subsequently adding the reinforcing filler and, if appropriate, the other ingredients of the rubber composition, with the exception of the crosslinking system, by thermomechanically kneading until a maximum temperature of between 13° and 200 °C is reached, in order to obtain a mixture,
cooling the mixture to a temperature of less than 100 °C,
subsequently incorporating the crosslinking system,
kneading the mixture and the crosslinking system up to a maximum temperature of less than 120 °C.

The contact time between the starting diene elastomer and the 1,3-dipolar compound which are thermomechanically kneaded is adjusted depending on the conditions of the thermomechanical kneading, in particular depending on the temperature. The higher the temperature of the kneading, the shorter this contact time. Typically, it is from 1 to 5 minutes for a temperature of 100 to 130 °C.

According to this particular embodiment of the invention, an antioxidant is preferably added to the starting diene elastomer before thermomechanically kneading it, in particular at the end of the synthesis of the starting diene elastomer, as is done conventionally.

The final composition thus obtained may then be calendered, for example in the form of a sheet or a slab, or else extruded, for example in order to form a rubber profiled element used for the manufacture of a semi-finished product, such as, for example, a tread for a tire.

The rubber composition in accordance with the invention, which may be either in the green state (before crosslinking or vulcanization) or in the cured state (after crosslinking or vulcanization), can be used in a semi-finished article for a tire. Preferably, the tire contains the rubber composition in its tread.

In summary, the invention is advantageously implemented according to any one of the following Embodiments 1 to 28:

Embodiment 1: Diene elastomer which is a copolymer of 1,3-butadiene and styrene and which is functionalized with pendent imidazole groups of formula (I)

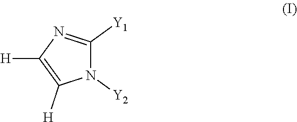

in which:
Y₁ represents a hydrogen atom or a carbon chain that may contain at least one heteroatom,
Y₂ denotes an attachment to a butadiene unit of the diene elastomer,
which diene elastomer contains 1,4-trans-linked butadiene units and 1,2-linked butadiene units,
the 1,4-trans-linked butadiene units representing more than 70 mol % of the butadiene units of the diene elastomer,
the 1,2-linked butadiene units representing less than 10 mol % of the butadiene units of the diene elastomer.

Embodiment 2: Diene elastomer according to Embodiment 1, wherein the 1,4-trans-linked butadiene units represent more than 75 mol % of the butadiene units of the diene elastomer.

Embodiment 3: Diene elastomer according to Embodiment 1 or 2, wherein the 1,2-linked butadiene units represent less than 8 mol % of the butadiene units of the diene elastomer.

Embodiment 4: Diene elastomer according to any one of Embodiments 1 to 3 which contains between 5% and 45% by mass of styrene.

Embodiment 5: Diene elastomer according to any one of Embodiments 1 to 4 which contains between 15% and 40% by mass of styrene.

Embodiment 6: Diene elastomer according to any one of Embodiments 1 to 5 which contains between 25% and 35% by mass of styrene.

Embodiment 7: Diene elastomer according to any one of Embodiments 1 to 6, wherein the molar content of pendent groups of formula (I) is at most 3 mol % of the constituent repeating units of the diene elastomer.

Embodiment 8: Diene elastomer according to any one of Embodiments 1 to 7, wherein Y₁ is a hydrogen atom or an alkyl group.

Embodiment 9: Diene elastomer according to Embodiment 8, wherein the alkyl group represented by Y₁ contains from 1 to 6 carbon atoms.

Embodiment 10: Diene elastomer according to Embodiment 8 or 9, wherein the alkyl group represented by Y₁ is methyl.

Embodiment 11: Diene elastomer according to any one of Embodiments 1 to 10, wherein the pendent imidazole groups are distributed randomly along the chain of the diene elastomer.

Embodiment 12: Diene elastomer according to any one of Embodiments 1 to 11, which diene elastomer is obtained by modifying a starting diene elastomer by a reaction of grafting a 1,3-dipolar compound,
the starting diene elastomer being a copolymer of 1,3-butadiene and styrene which contains more than 70 mol % of the 1,4-trans-linked butadiene units and less than 10 mol % of the 1,2-linked butadiene units, the molar percentages of the 1,4-trans-linked butadiene units and the 1,2-linked butadiene units being calculated relative to the total number of butadiene units in the starting diene elastomer,
the 1,3-dipolar compound being a compound containing a dipole selected from a nitrile oxide, a nitrile imine and a nitrone and containing a group of formula (II) in which Z₁ represents a hydrogen atom or a carbon chain that may contain at least one heteroatom and Z₂ denotes an attachment to the dipole,

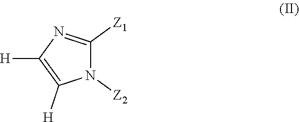

Embodiment 13: Diene elastomer according to Embodiment 12, wherein the 1,3-dipolar compound is an aromatic compound which contains a single nitrile oxide dipole.

Embodiment 14: Diene elastomer according to Embodiment 12 or 13, wherein the 1,3-dipolar compound is a compound which contains a benzene ring and which contains a single nitrile oxide dipole and in which the benzene ring is substituted by the nitrile oxide dipole, preferably in the ortho position.

Embodiment 15: Diene elastomer according to any one of Embodiments 12 to 14, wherein the 1,3-dipolar compound contains a moiety of formula (III) in which four of the six symbols R₁ to R₆, which may be identical or different, are each an atom or a group of atoms, knowing that the fifth symbol represents an attachment to the group of formula (II) and the sixth symbol a direct attachment to the dipole.

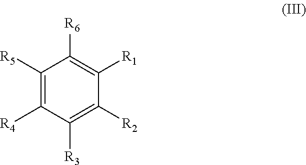

Embodiment 16: Diene elastomer according to Embodiment 15, wherein R₆ represents a direct attachment to the dipole, and the symbols R₁ and R₅ are both other than a hydrogen atom.

Embodiment 17: Diene elastomer according to Embodiment 15 or 16, wherein the symbols R₁, R₃ and R₅ each represent an alkyl.

Embodiment 18: Diene elastomer according to any one of Embodiments 15 to 17, wherein the symbols R₁, R₃ and R₅ each represent a methyl or ethyl, and one of the symbols R₂ and R₄ is a hydrogen atom.

Embodiment 19: Diene elastomer according to any one of Embodiments 15 to 18, wherein the fifth symbol is attached to the group of formula (II) via an alkanediyl group, preferentially a methanediyl group.

Embodiment 20: Diene elastomer according to any one of Embodiments 15 to 18, wherein the 1,3-dipolar compound is of formula (III-a) or (III-b), preferentially (III-a).

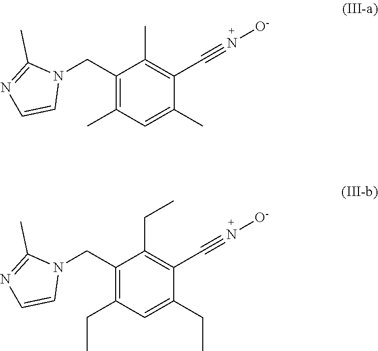

Embodiment 21: Rubber composition which comprises a diene elastomer which is a copolymer of 1,3-butadiene and styrene and which is functionalized with pendent imidazole groups, a reinforcing filler, and a crosslinking system, which diene elastomer is defined in any one of Embodiments 1 to 20.

Embodiment 22: Rubber composition according to Embodiment 21, wherein the reinforcing filler contains a carbon black.

Embodiment 23: Rubber composition according to Embodiment 22, wherein the carbon black represents more than 50% by mass of the reinforcing filler.

Embodiment 24: Rubber composition according to Embodiment 22 or 23, wherein the carbon black represents more than 90% by mass of the reinforcing filler.

Embodiment 25: Rubber composition according to any one of Embodiments 21 to 24, wherein the total content of the reinforcing filler is between 40 and 80 phr.

Embodiment 26: Rubber composition according to any one of Embodiments 21 to 25, in which the crosslinking system is a vulcanization system.

Embodiment 27: Process for preparing a rubber composition defined in any one of Embodiments 21 to 26, which process comprises the following steps:
during a “non-productive” step, kneading a starting diene elastomer and a 1,3-dipolar compound by thermomechanically kneading,
the starting diene elastomer being a copolymer of 1,3-butadiene and styrene which contains more than 70 mol % of 1,4-trans-linked butadiene units and less than 10 mol % of 1,2-linked butadiene units, the molar percentages of the 1,4-trans-linked butadiene units and the 1,2-linked butadiene units being calculated relative to the total number of butadiene units in the starting diene elastomer,
the 1,3-dipolar compound being a compound containing a dipole selected from nitrile oxide, nitrile imine and nitrone and containing a group of formula (II) in which Z₁ represents a hydrogen atom or a carbon chain that may contain at least one heteroatom and Z₂ denotes an attachment to the dipole,

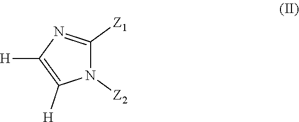

subsequently adding the reinforcing filler and, if appropriate, the other ingredients of the rubber composition, with the exception of the crosslinking system, by thermomechanically kneading until a maximum temperature of between 13° and 200 °C is reached, in order to obtain a mixture,
cooling the mixture to a temperature of less than 100 °C,
subsequently incorporating the crosslinking system,
kneading the mixture and the crosslinking system up to a maximum temperature of less than 120 °C.

Embodiment 28: Tire comprising a rubber composition preferentially in its tread, which rubber composition is defined in any one of Embodiments 21 to 26 or obtained according to a process defined in Embodiment 27.

The abovementioned features of the present invention, and also others, will be better understood on reading the following description of a number of exemplary embodiments of the invention, which are given by way of illustration.

### EXAMPLES

### II.1—Measurements and Tests

### Determination of the Microstructure and the Function Content of the Elastomers by Nuclear Magnetic Resonance (NMR):

The microstructure is determined by 1H NMR. The molar content of grafted nitrile oxide compound is also determined by NMR analysis. The samples are dissolved in a mixture of carbon disulfide and deuterated benzene (CS₂/C₆D₆ (50/50)) for the purpose of obtaining a “lock” signal. The spectra are acquired on a Bruker 500 MHz spectrometer equipped with a “5 mm BBFO Z-grad CryoProbe” probe. The quantitative 1H NMR experiment uses a simple 30° pulse sequence and a repetition time of 5 seconds between each acquisition. 2D NMR experiments make it possible to confirm the nature of the grafted unit by virtue of the chemical shifts of the carbon atoms and protons.

### Glass Transition Temperature of the Elastomers:

The glass transition temperature (Tg) is measured by means of a differential scanning calorimeter according to the standard ASTM D3418 (1999).

### Mooney Viscosity:

The Mooney viscosity is measured using an oscillating consistometer as described in the standard ASTM D1646 (1999). The measurement is carried out according to the following principle: the sample, analysed in the green state (i.e., before curing), is moulded (shaped) in a cylindrical chamber heated to a given temperature (100 °C). After preheating for 1 minute, the rotor rotates within the test specimen at 2 revolutions/minute and the effective torque for maintaining this movement is measured after rotating for 4 minutes. The Mooney viscosity (ML) is expressed in “Mooney unit” (MU, with 1 MU=0.83 newton·metre).

### Crack Propagation Resistance:

The rate of cracking was measured on test specimens of rubber compositions using a cyclic fatigue device (Elastomer Test System) of the 381 type from MTS, as explained below.

The resistance to cracking is measured using repeated tensile actions on a test specimen initially accommodated (after a first tensile cycle) and then notched. The tensile test specimen is composed of a rubber slab of parallelepipedal shape, for example with a thickness of between 1 and 2 mm, with a length between 130 and 170 mm and with a width between 10 and 15 mm, the two side edges each being covered lengthwise with a cylindrical rubber bead (diameter 5 mm) for anchoring in the jaws of the tensile testing device. The test specimens thus prepared are tested in the fresh state. The test was carried out in air, at a temperature of 80 °C. After accommodation, 3 very fine notches with a length of between 15 and 20 mm are produced using a razor blade, at mid-width and aligned in the direction of the length of the test specimen, one at each end and one at the centre of the latter, before starting the test. At each tensile cycle, the degree of deformation of the test specimen is automatically adjusted so as to keep the energy release rate (amount of energy released during the progression of the crack) constant at a value of less than or equal to approximately 300 J/m².

The crack propagation rate is measured in nanometres per cycle. The crack propagation resistance will be expressed in relative units (r.u.) by dividing the propagation rate of the control by that of the mixture, the rates being measured at the same energy release rate. A value greater than that of the control, arbitrarily set at 100, indicates an improved result, that is to say a greater crack propagation resistance.

### II.2—Preparation of the Rubber Compositions

The formulation of the rubber compositions (in phr) is shown in Table 1.

For the manufacture of compositions T1 to T4, the procedure is as follows: the elastomer is introduced into an internal mixer (final degree of filling: approximately 70% by volume), the initial tank temperature of which is approximately 80 °C, followed by the reinforcing filler, and also the various other ingredients with the exception of the vulcanization system. Thermomechanical working (non-productive phase) is then carried out in one step, which lasts approximately 5 min to 6 minutes, until a maximum “dropping” temperature of 160 °C is reached. The mixture thus obtained is recovered and cooled and then sulfur and an accelerator of sulfenamide type are incorporated on a mixer (homofinisher) at 23 °C, everything being mixed (productive phase) for an appropriate time (for example between 5 and 12 min).

In the case of the rubber compositions C1 to C4, the procedure is as mentioned for the compositions T1 to T4 except that before introducing the reinforcing filler, the 1,3-dipolar compound is introduced and is kneaded alone with the elastomer for 1 minute at 120 °C, thereby making it possible to functionalize the elastomer with pendent groups of formula (I) before introducing the other ingredients of the rubber composition.

The content of 1,3-dipolar compound introduced into the internal mixer in order to functionalize the elastomer before introducing the other ingredients of the rubber composition is shown in Table 1 and is expressed in phr. The content introduced corresponds to a molar degree of modification of 0.5 mol per 100 mol of the monomer units of the functional elastomer.

The compositions thus obtained are subsequently calendered, either in the form of slabs (with a thickness ranging from 2 to 3 mm) or thin sheets of rubber, for the measurement of their physical or mechanical properties after vulcanization at 150 °C (cured state), or in the form of profiled elements which can be used directly, after cutting and/or assembling to the desired dimensions, for example as semi-finished products for tires, in particular as treads for tires.

The rubber compositions C₁ to C₄ all contain an elastomer functionalized with imidazole functions, since the elastomer is modified with the 1,3-dipolar compound of formula (III-a).

The rubber compositions T1 to T4 contain no functional elastomer and are the control compositions of compositions C1 to C4, respectively.

Only composition C1 contains a diene elastomer in accordance with the invention which is a copolymer of styrene and 1,3-butadiene functionalized with pendent imidazole functions of formula (I) and in which the 1,4-trans-linked butadiene units represent more than 70 mol % of the butadiene units of the diene elastomer and the 1,2-linked butadiene units represent less than 10 mol % of the butadiene units of the diene elastomer. The composition C1 is a composition in accordance with the invention. Compositions C₂ to C₄ are not in accordance with the invention.

### II.3—Results

The results of the properties in the cured state of the rubber compositions are given in Table 2.

The greatest improvement in the crack propagation resistance resulting from the functionalization of the diene elastomer is observed for the composition C1.

Specifically, compared to its control composition, the crack propagation resistance is multiplied by a factor of 1.7 while the compositions not in accordance with the invention C2 and C3, which also contain an SBR, have a performance much lower than that of their respective control. It is recalled that the composition C1 differs from the compositions C2 and C3 in that the SBR in C1 is an SBR in which the 1,4-trans-linked butadiene units and 1,2-linked butadiene units respectively represent more than 70 mol % and less than 10 mol % of the butadiene units of the elastomer.

The composition C4, which also contains an elastomer having a strong stereospecificity, in this case a BR with a 1,4-cis bond content of more than 98%, has performance identical to that of its control T4.

In summary, the improvement in performance is observed only in the case of an SBR elastomer functionalized with pendent imidazole groups of formula (I) in which the 1,4-trans-linked butadiene units and 1,2-linked butadiene units respectively represent more than 70 mol % and less than 10 mol % of the butadiene units of the elastomer and which bears pendent imidazole functions.

TABLE 1

| Composition | T1 | T2 | T3 | T4 | C1 | C2 | C3 | C4 |
|---|---|---|---|---|---|---|---|---|
| SBR (1) | 100 | 0 | 0 | 0 | 100 | 0 | 0 | 0 |
| SBR (2) | 0 | 100 | 00 | 0 | 0 | 100 | 0 | 0 |
| SBR (3) | 0 | 0 | 100 | 0 | 0 | 0 | 100 | 0 |
| BR (4) | 0 | 0 | 0 | 100 | 0 | 0 | 0 | 100 |
| Carbon black (5) | 60 | 60 | 60 | 60 | 60 | 60 | 60 | 60 |
| Resin (6) | 5 | 5 | 5 | 5 | 5 | 5 | 5 | 5 |
| Antioxidant (7) | 2.5 | 2.5 | 2.5 | 2.5 | 2.5 | 2.5 | 2.5 | 2.5 |
| Anti-ozone wax | 1 | 1 | 1 | 1 | 1 | 1 | 1 | 1 |
| Stearic acid (8) | 0.5 | 0.5 | 0.5 | 0.5 | 0.5 | 0.5 | 0.5 | 0.5 |
| ZnO (9) | 2 | 2 | 2 | 2 | 2 | 2 | 2 | 2 |
| Sulfur | 1.2 | 1.2 | 1.2 | 1.2 | 1.2 | 1.2 | 1.2 | 1.2 |
| CBS (10) | 1.1 | 1.1 | 1.1 | 1.1 | 1.1 | 1.1 | 1.1 | 1.1 |
| Compound III-a (11) | 0 | 0 | 0 | 0 | 2.2 | 2.2 | 2.2 | 2.2 |

(1) Copolymer of styrene and 1,3-butadiene of Tg −52 °C and ML 54, containing 29.5% by mass of styrene; 79% of the butadiene units being 1,4-trans linked; 5% of the butadiene units being 1,2-linked,
(2) Copolymer of styrene and 1,3-butadiene (SBR 1500) of Tg −52 °C and ML 51, containing 23.5% by mass of styrene; 70% of the butadiene units being 1,4-trans linked; 16% of the butadiene units being 1,2-linked,
(3) Copolymer of styrene and 1,3-butadiene of Tg −48 °C and ML 54, containing 26.5% by mass of styrene; 50% of the butadiene units being 1,4-trans linked; 24% of the butadiene units being 1,2-linked,
(4) Homopolymer of 1,3-butadiene of Tg −108 °C and ML 44; 98% of the butadiene units being 1,4-cis linked,
(5) HAF carbon black,
(6) Alkylphenol tackifying thermoplastic resin (“SP1068” from SI Group-Bethune),
(7) N-(1,3-dimethylbutyl)-N′-phenyl-p-phenylenediamine from Flexsys/2,2,4-trimethyl-1,2-dihydroquinoline “Pilnox TMQ” from Nocil 60/40 (by mass)
(8) Stearin, “Pristerene 4931” from Uniqema,
(9): Zinc oxide, industrial grade - from Umicore,
(10) “Santocure” from Flexsys (N-cyclohexyl-2-benzothiazolesulfenamide),
(11) 2,4,6-trimethyl-3-((2-methyl-1H-imidazol-1-yl)methyl)benzonitrile oxide synthesized according to the procedure described in the patent application WO 2015059269.

(1) Copolymer of styrene and 1,3-butadiene of Tg-52 °C and ML 54, containing 29.5% by mass of styrene; 79% of the butadiene units being 1,4-trans linked; 5% of the butadiene units being 1,2-linked,
(2) Copolymer of styrene and 1,3-butadiene (SBR 1500) of Tg-52 °C and ML 51, containing 23.5% by mass of styrene; 70% of the butadiene units being 1,4-trans linked; 16% of the butadiene units being 1,2-linked,
(3) Copolymer of styrene and 1,3-butadiene of Tg-48 °C and ML 54, containing 26.5% by mass of styrene; 50% of the butadiene units being 1,4-trans linked; 24% of the butadiene units being 1,2-linked,
(4) Homopolymer of 1,3-butadiene of Tg-108 °C and ML 44; 98% of the butadiene units being 1,4-cis linked,
(5) HAF carbon black,
(6) Alkylphenol tackifying thermoplastic resin (“SP1068” from SI Group-Bethune),
(7) N-(1,3-dimethylbutyl)-N′-phenyl-p-phenylenediamine from Flexsys/2,2,4-trimethyl-1,2-dihydroquinoline “Pilnox TMQ” from Nocil 60/40 (by mass)
(8) Stearin, “Pristerene 4931” from Uniqema,
(9): Zinc oxide, industrial grade—from Umicore,
(10) “Santocure” from Flexsys (N-cyclohexyl-2-benzothiazolesulfenamide),
(11) 2,4,6-trimethyl-3-((2-methyl-1H-imidazol-1-yl)methyl)benzonitrile oxide synthesized according to the procedure described in the patent application WO 2015059269.

TABLE 2

| Composition | T1 | C1 | T2 | C2 | T3 | C3 | T4 | C4 |
|---|---|---|---|---|---|---|---|---|
| Crack propagation | 100 | 171 | 100 | 55 | 100 | 17 | 100 | 100 |
| resistance | | | | | | | | |
| 300 J/m² | | | | | | | | |

1. A diene elastomer which is a copolymer of 1,3-butadiene and styrene and which is functionalized with pendent imidazole groups of formula (I) 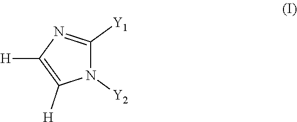
in which:
Y₁ represents a hydrogen atom or a carbon chain that may contain at least one heteroatom,
Y₂ denotes an attachment to a butadiene unit of the diene elastomer,
which diene elastomer contains 1,4-trans-linked butadiene units and 1,2-linked butadiene units,
the 1,4-trans-linked butadiene units representing more than 70 mol % of the butadiene units of the diene elastomer, and
the 1,2-linked butadiene units representing less than 10 mol % of the butadiene units of the diene elastomer.

2. The diene elastomer according to claim 1, wherein the 1,4-trans-linked butadiene units represent more than 75 mol % of the butadiene units of the diene elastomer.

3. The diene elastomer according to claim 1, wherein the 1,2-linked butadiene units represent less than 8 mol % of the butadiene units of the diene elastomer.

4. The diene elastomer according to claim 1, which contains between 5% and 45% by mass of styrene.

5. The diene elastomer according to claim 1, wherein the molar content of pendent groups of formula (I) is at most 3 mol % of the constituent repeating units of the diene elastomer.

6. The diene elastomer according to claim 1, wherein Y₁ is a hydrogen atom or an alkyl group.

7. The diene elastomer according to claim 6, wherein the alkyl group represented by Y₁ contains from 1 to 6 carbon atoms, and is preferentially methyl.

8. The diene elastomer according to claim 1, wherein the pendent imidazole groups are distributed randomly along the chain of the diene elastomer.

9. A rubber composition which comprises a diene elastomer which is a copolymer of 1,3-butadiene and styrene and which is functionalized with pendent imidazole groups, a reinforcing filler, and a crosslinking system, which diene elastomer is defined in claim 1.

10. The rubber composition according to claim 9, wherein the reinforcing filler contains a carbon black.

11. The rubber composition according to claim 10, wherein the carbon black represents more than 50%, preferentially more than 90%, by mass of the reinforcing filler.

12. The rubber composition according to claim 9, wherein the total content of the reinforcing filler is between 40 and 80 phr.

13. The rubber composition according to claim 1, in which the crosslinking system is a vulcanization system.

14. A process for preparing a rubber composition defined in claim 9, which process comprises the following steps:
during a “non-productive” step, kneading a starting diene elastomer and a 1,3-dipolar compound by thermomechanically kneading,
the starting diene elastomer being a copolymer of 1,3-butadiene and styrene which contains more than 70 mol % of the 1,4-trans-linked butadiene units and less than 10 mol % of the 1,2-linked butadiene units, the molar percentages of the 1,4-trans-linked butadiene units and the 1,2-linked butadiene units being calculated relative to the total number of butadiene units in the starting diene elastomer,
the 1,3-dipolar compound being a compound containing a dipole selected from nitrile oxide, nitrile imine and nitrone and containing a group of formula (II) in which Z₁ represents a hydrogen atom or a carbon chain that may contain at least one heteroatom and Z₂ denotes an attachment to the dipole, 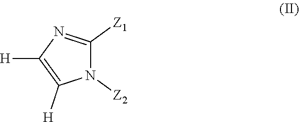
subsequently adding the reinforcing filler and, optionally, the other ingredients of the rubber composition, with the exception of the crosslinking system, by thermomechanically kneading until a maximum temperature of between 13° and 200 °C is reached, in order to obtain a mixture,
cooling the mixture to a temperature of less than 100 °C,
subsequently incorporating the crosslinking system, and
kneading the mixture and the crosslinking system up to a maximum temperature of less than 120 °C.

15. A tire comprising a rubber composition, which rubber composition is defined in claim 9.

16. The tire of claim 15, wherein the rubber composition is located in a tread of the tire.

17. The diene elastomer according to claim 4, which contains between 15% and 40% by mass of styrene.

18. The diene elastomer according to claim 4, which contains between 25% and 35% by mass of styrene.

19. The diene elastomer according to claim 6, wherein the alkyl group represented by Y₁ is methyl.

20. The rubber composition according to claim 10, wherein the carbon black represents more than 90% by mass of the reinforcing filler.
